(19) United States
(12) Patent Application Publication
(10) Pub. No.: US 2002/0004728 A1
(43) Pub. Date: Jan. 10, 2002

(54) Testing method and system

(76) Inventors: Richard A. Quattrocchi, Barrington, IL (US); Michael Wandell, Mercer Island, WA (US); Brian McDonald, Bartlett, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 09/834,451

(22) Filed: Apr. 13, 2001

Related U.S. Application Data
(60) Provisional application No. 60/197,963, filed on Apr. 17, 2000.

(51) Int. Cl. G06F 17/60

(52) U.S. Cl. 705/3

(57) ABSTRACT

Disclosed are methods and systems useful in connection with medical testing systems. A user initiates an inquiry to a facility equipped to receive such inquiries. The facility routes the inquiry based on various parameters, such as whether the user's identification code is associated with a code lot. The facility may perform various associations between the user's test result information and other information, such as risk assessment information.

### RELATED APPLICATION

This application claims priority to prior U.S. provisional application Ser. No. 60/197,963 filed Apr. 17, 2000.

### TECHNICAL FIELD OF THE INVENTION

The invention is in the field of testing systems and methods. The invention finds particular applicability in the field of medical testing system and methods.

### BACKGROUND OF THE INVENTION

Numerous testing methods and systems are known in the art. In recent years, for instance, a number of methods and systems for permitting anonymous medical testing have been provided. For example, U.S. Pat. No. 6,016,345, issued to Richard Quattrocchi and assigned to Home Access Health Corporation of Hoffman Estates, Illinois provides a method and system for anonymously testing for a human malady. The method disclosed in the '345 patent contemplates, inter alia, selecting a call handler from among a plurality of call handlers for processing an incoming telephone call initiated by an anonymous caller. The disclosed method may be used to route the incoming call to a live call handler in the event that the anonymous caller has been diagnosed with a specific medical condition, and to an automated call handler if the anonymous caller has been found not to be afflicted with the medical condition. Commercially, the method taught in the '345 patent has been used in connection with anonymous testing for the human immunodeficiency virus (HIV), which is the virus that causes AIDS. U.S. Pat. No. 6,014,438 and 5,978,466, also issued to Richard Quattrocchi and assigned to Home Access Health Corporation, disclose other methods and systems useful in conjunction with the operation of an anonymous testing system. The methods and systems disclosed in the foregoing patents are particularly applicable to medical testing, but more generally are applicable to other forms of testing, such as environmental or other testing.

The present invention seeks to provide other methods and systems useful in conjunction with a testing system, in particular a medical testing system. In various preferred embodiments, the methods provided by the present invention may be practiced by a medical facility in conjunction with the methods taught in the aforementioned Quattrocchi patents.

### THE INVENTION

Numerous testing methods and systems are contemplated by the present invention. In one embodiment, a method for routing a plurality of incoming inquiries initiated by a plurality of users is provided. Each of the users will have previously provided a specimen for evaluation to a testing facility prior to making an incoming inquiry. The test result information (such as medical test information) from said test specimen is associated with a code. Some, but not necessarily all, of the codes that have been provided to users are associated with a code lot. In accordance with this embodiment of the invention, a handler for an incoming inquiry initiated by one of the users is selected based in part on whether the user's code corresponds to a code lot. The inquiry may be made via a telephone call or via other forms of electronic communication, and the handler for the incoming inquiry may be “selected” either by selecting a handler assigned solely to handle incoming inquiries from users assigned to the code lot, or by preparing lot-specific instructions for a handler assigned commonly to all users of the testing system. For instance, the inquiry handler may provide specific medical information to users who fall within a certain group or class of users. This embodiment of the invention is particularly applicable to medical testing of groups of users, such as employees of a company. It may be desired to have all of the company's employees tested for a certain medical condition or for other medical purposes (e.g. as part of a cholesterol testing program or other medical wellness program). The employees may be tested anonymously, with each employee's specimen being identified only by a specimen code. Upon receipt of an incoming inquiry initiated by one of the employees, the facility handling the inquiry provides the employee with the results of the test. If the employee's code is associated with a code lot known to be assigned to the company, the facility can provide specific medical information concerning the employer's insurance benefits, wellness benefits, or other information tailored specifically for employees of the company.

Another related testing method includes selecting a counselor for a user who desires counseling. In accordance with this method, the counselor is selected based on whether the user's personal or specimen identification code is grouped into a code lot. Thus, for instance, a user who initiates an incoming inquiry to a call handling facility may desire to obtain counseling concerning the test, either before or after the user receives the results of the test. If it is known that the user's code is assigned to a code lot (for instance, a code lot for employees of a specific company), numerous benefits may be realized by selecting a counselor specific to the company at which the user is employed and routing the user's inquiry to such counselor. For example, the counseling provided to the user may be more specifically tailored to the user if it is known that the user works for a particular company or in a particular industry. In addition, where the counselor knows that the user works for a specific company, the counselor may be able to provide the user with information relating to the user's insurance benefits. The step of “selecting a counselor” may include either selecting a counselor who is assigned solely to users corresponding to the code lot, or preparing an instruction message to a counselor who is assigned commonly to all users.

In accordance with other embodiments in the invention, methods for associating information specific to the user with the user's test result are provided. It has been found that a user who has received a test result, in particular a medical test result, sometimes desires to record the fact that he or she has taken the test and obtained a test result, even though the test result initially may have been obtained anonymously. For instance, if a person who has been tested for the human immunodeficiency virus (HIV) learns that he or she has received a negative test for the virus, he or she may wish to obtain a record of his or her test status for insurance or other purposes. Accordingly, in accordance with this embodiment of the invention, the user may be queried as to whether the user desires test result information to be identified with information specific to the user. In accordance with one such method, information is received from a plurality of users, the information from any one user being specific to the user and being associated with a first identification number. The user also is provided with a second, independent identification number, which is associated with the user's test specimen. In accordance with this embodiment of the invention, the user is queried as to whether the user desires test result information to be identified with the information specific to the user. Typically, the user is so queried after the user has received his or her test results. In response to an indication from the user that the user does so desire, the user is then prompted for his or her first identification number, and the first and second identification numbers are linked in a database to thereby associate the information specific to the user with the test result information. The information specific to the user may be information sufficient to identify the user, and/or may be other information specific to the user, such as, for instance, risk assessment information.

In another embodiment, the user is provided with an identification code, which code is associated with risk assessment information. Upon receipt of an incoming inquiry, the facility receiving the inquiry prompts the user to transmit his or her user identification code. If the user desires user identifying information to be associated with the test result information from a specimen submitted by the user, the user identifying information is obtained and is associated with the test result information. The user identifying information may be obtained even after the test has been performed and the results have been provided to the user. For instance, the user may be queried for the user identifying information.

Where the information specific to the user includes risk assessment information, it may be useful for statistical and other analytical purposes to correlate test result information with risk assessment information. Provided herein are methods for associating test result information with risk assessment information. In accordance with one such method, information received from each of plural users is associated with a user identification code, where the code for each user is unique to the user. The information for each user includes risk assessment information. The user also is provided with a second identification code that is associated with the user's test specimen. Upon receiving an incoming inquiry initiated by one of the users, the user is prompted to transmit his or her user identification code. After the user has been prompted to transmit his or her specimen identification code, test result information from the test is associated with risk assessment information.

Another method provided herein finds particular applicability in health screening and diagnostic applications. In accordance with this method, risk assessment information is received from a plurality of users, the risk assessment information from any one user being specific to the user and being associated with a user code. After receipt of an inquiry from one of the users, the user is prompted for his or her user code. Subsequently a determination is made as to whether, based on the risk assessment information, a recommendation to obtain testing should be provided. After selecting an appropriate recommendation provider based on this determination, the user's inquiry is routed to the selected recommendation provider. The step of “selecting” a recommendation provider may include selecting a recommendation provider who is assigned solely to provide recommendations to certain classes of users (for instance, users at high risk for a given medical condition or users at low risk for such condition). Alternatively the step of “selecting” may encompass preparing instructions for a common recommendation provider.

The invention also encompasses systems for performing any or all of the foregoing methods. The methods and systems disclosed herein find particular applicability in the field of medical testing, but also are useful in other fields, such as environmental testing.

### DESCRIPTION OF THE DRAWINGS

FIG. 1 is a generalized representation of a medical testing protocol known in the prior art.

FIG. 2 is a flowchart illustrating steps in a prior art method for collecting test samples, testing the samples, and providing test results.

FIG. 3 is a generalized schematic representation of the flow of communication between a central testing facility and others in a testing system in accordance with the invention.

FIG. 4 is a representation of a personal code database correlating a user's identification code with lot codes and with other information.

FIG. 5 is a representation of the database record entry U-1 in the database represented in FIG. 4.

FIG. 6 is a representation of the database record entry R-1 in the database represented in FIG. 4.

FIG. 7 is a representation of a specimen code database in which specimen codes are correlated with test result information and other information.

FIG. 8 is a representation of database record entry T-1 in the database represented in FIG. 7.

FIG. 9 is a representation of a first alternative embodiment of a bank of inquiry handlers useful in conjunction with the practice of this invention.

FIG. 10 is a representation of a second alternative embodiment of a bank of inquiry handlers useful in conjunction with the practice of the invention.

FIG. 11 is a flowchart illustrating steps in a method for routing incoming inquiries based on whether the user code is associated with a code lot.

FIG. 12 is a representation of a first alternative embodiment of a bank of counselors useful in conjunction with the practice of the invention.

FIG. 13 is a representation of a second alternative embodiment of a bank of counselors useful in conjunction with the practice of the invention.

FIG. 14 is a flowchart illustrating steps in a method associating test result information with user identifying information at the option of the inquirer.

FIG. 15 is a flowchart illustrating steps in another method for associating test result information with user identifying information at the option of the inquirer.

FIG. 16 is a flowchart illustrating steps in a method for associating test result information with risk assessment information.

FIG. 17 is a flowchart illustrating steps in a method for selecting a recommendation provider based on risk assessment information.

FIG. 18 is a representation of a first alternative embodiment of a bank of recommendation providers useful in conjunction with the practice of the invention.

FIG. 19 is a representation of a second alternative embodiment of a bank of recommendation providers useful in conjunction with the practice of the invention.

FIG. 20 is a high-level block diagram of a general-purpose computer system useful in conjunction with the practice of the invention.

### DESCRIPTION OF THE PREFERRED EMBODIMENT

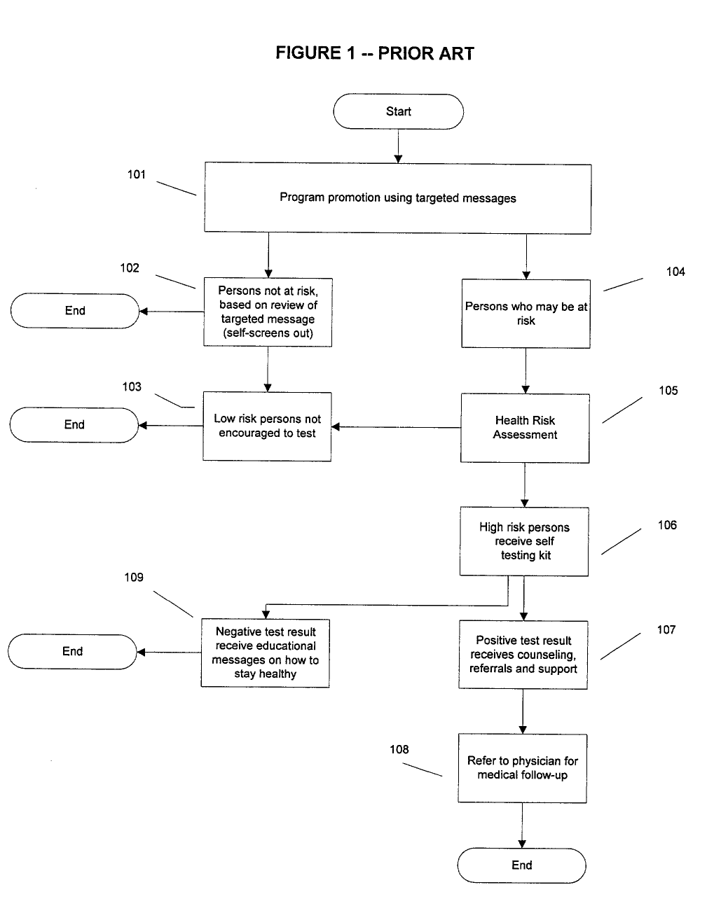

The methods and systems provided herein preferably are used in conjunction with a medical testing program. With reference now to FIG. 1 and the general medical testing protocol shown therein, the medical testing program may be promoted using advertising or other targeted messages, as shown at step 101. For instance, the advertising may be targeted to persons at risk for a given medical condition, such as HIV infection. Persons who determine, based on the targeted messages, that they are not at risk for the medical condition may not apply for testing; if such persons do submit for testing, they are not encouraged to take a test, as shown at steps 102 and 103 respectively. Persons who may be at risk are identified at step 104 and provided with a more detailed health risk assessment at step 105. If, based on the health risk assessment, it is determined that the person is of low risk for the medical condition, the person is not encouraged to submit to testing. Persons who are deemed to be at high risk receive a self-testing kit, as shown at step 106. A specimen is collected by the person and is submitted for testing to a testing facility (steps not shown). If the person receives a negative test result, her or she is provided with educational messages, wellness counseling, or other suitable information at step 109. Persons who receive a positive test result are provided with counseling referrals and support, and are referred to a physician for medical follow up at steps 107 and 108 respectively.

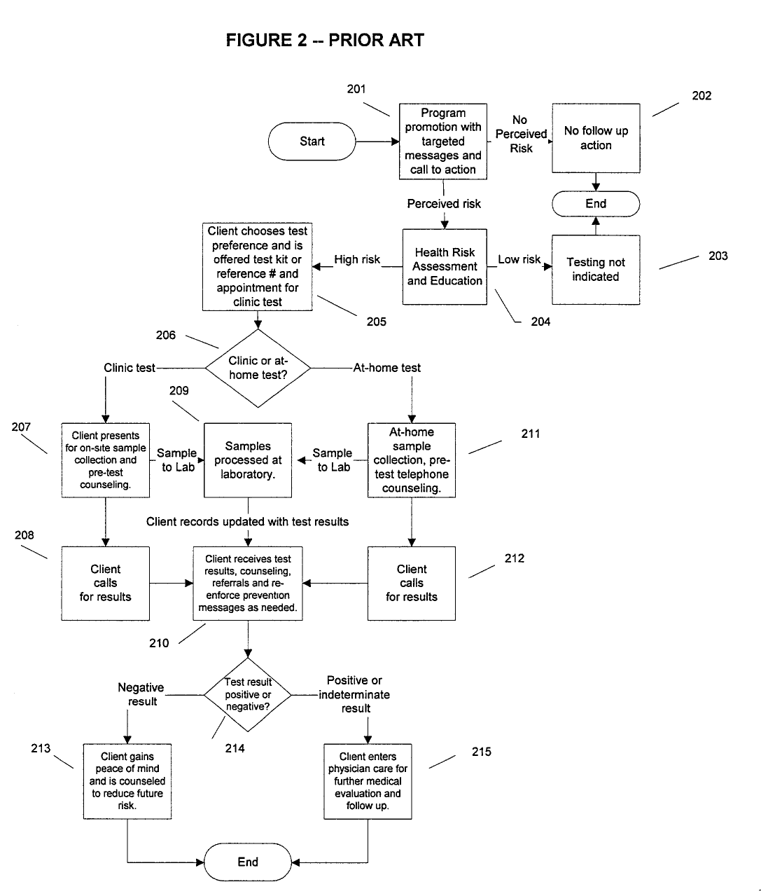

Referring now more specifically to FIG. 2, upon receipt of targeted messages and evaluation as a high risk candidate via a health risk assessment (as shown generally at steps 201 to 204), the client may be offered a test kit, whereupon the client can obtain a medical specimen. Numerous types of medical specimens may be obtained; for instance, saliva, urine, or other bodily fluids. In accordance with one embodiment, the user is provided with a blood specimen collection card and a skin pricking device. The user may obtain a blood specimen by placing a drop of blood onto the card and allowing the blood to dry, thus forming a blood spot on the card. In the alternative, the client may be provided with an appointment for a clinic test, as shown at step 205, whereby the specimen is obtained at the clinic. As shown generally at steps 206, 207, 209 and 211, regardless of whether the client chooses the clinic test or the self test, the client's medical specimen is processed in a laboratory, and the records for the client are updated with the results of the test.

To retrieve the test result, as shown generally at steps 208, 210 and 212, the client initiates an inquiry to a facility equipped to handle such inquiries, typically by way of a telephone call. At step 214, a determination is made as to whether the test result is positive or negative. As shown at step 213, if the test result is negative, the client is counseled to structure his or her activities to reduce future risk. Upon receipt of a positive or indeterminate result, the client is instructed to enter physician care for further medical evaluation and follow-up, as shown at step 215.

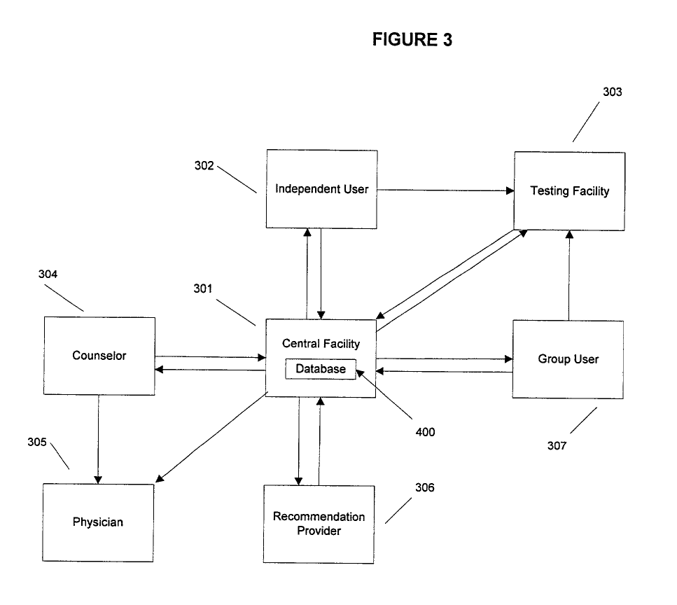

The methods and systems disclosed herein are suitable for use in conjunction with the known testing methods heretofore described. Generally, as shown in FIG. 3, the testing system of the invention a central facility 301, which comprises a facility that is equipped to receive and respond to incoming inquiries initiated by a plurality of users. It is contemplated that the user may initiate an inquiry via any form of remote communication known in the art or otherwise found to be suitable for use in connection with the invention. For instance, it is contemplated that a user may communicate with a central facility via telephone, electronic mail, network access (such as over the Internet) via a “chat” or other application, or via other means of communication. The system may be used by independent users (one shown as independent user 302), who are users who are not known to fall within a code lot, and by group users (one shown as group user 307) who are users whose codes have been assigned to one or more code lots.

With reference to independent user 302, the user may purchase or otherwise be provided with a test kit for use in testing a specimen, such as a medical specimen. The user transmits the test specimen to a testing facility 303. In the figure, the testing facility is shown as a separate entity from the central facility 301, but in practice the testing facility may be integrated with the central facility, i.e., the steps of testing the specimens and handling user inquiries may be performed by the same entity. After the user has submitted the test specimen, the user contacts the central facility 301 and makes an inquiry for test-related information. In making that inquiry, the user provides a user code. The central facility makes a request for the test results to the testing facility, and provides the test result to the user 302. Where appropriate, the user is referred to a counselor 304 or to a physician 305, either by the counselor or by the central facility 301. As with the testing facility, the counselor 304 and physician 405 are shown in FIG. 3 as being separate entities from the central facility and from the testing facility, but in practice may be integral with one or more of the foregoing. It is further contemplated that a user 302 may further contact the central facility 301 as part of a health screening program, wherein the user provides risk assessment information to the central facility 301. In this instance, a determination is made as to whether the user should be provided with a recommendation to be tested, for instance, for a specific medical condition. Once such a determination has been made, the user's inquiry is routed to a recommendation provider 306, which again is shown as a separate entity from the central facility, but which may be integral therewith or which may be the same entity as a counselor or physician. In FIG. 3, the communication between the users 302 and 307 and the counselor 304, physician 305 and recommendation provider 306 are shown as proceeding via central facility 301, although in practice it is contemplated that the users alternatively may communicate independently with a counselor, physician or recommendation provider.

In carrying out the invention, the central facility maintains one or more databases that correlate user codes with identifying information, risk assessment information, or other information. The databases may be implemented using conventional or otherwise suitable database programs, such as a conventional relational database program. Examples of such programs include the Oracle products commercially available from Oracle Corporation of Redwood Shores, Calif., and the Microsoft Access programs available from Microsoft Corporation of Redmond, Wash. Virtual databases may also be used. The database may be a dimensional database, or may be implemented with a non-dimensional database software.

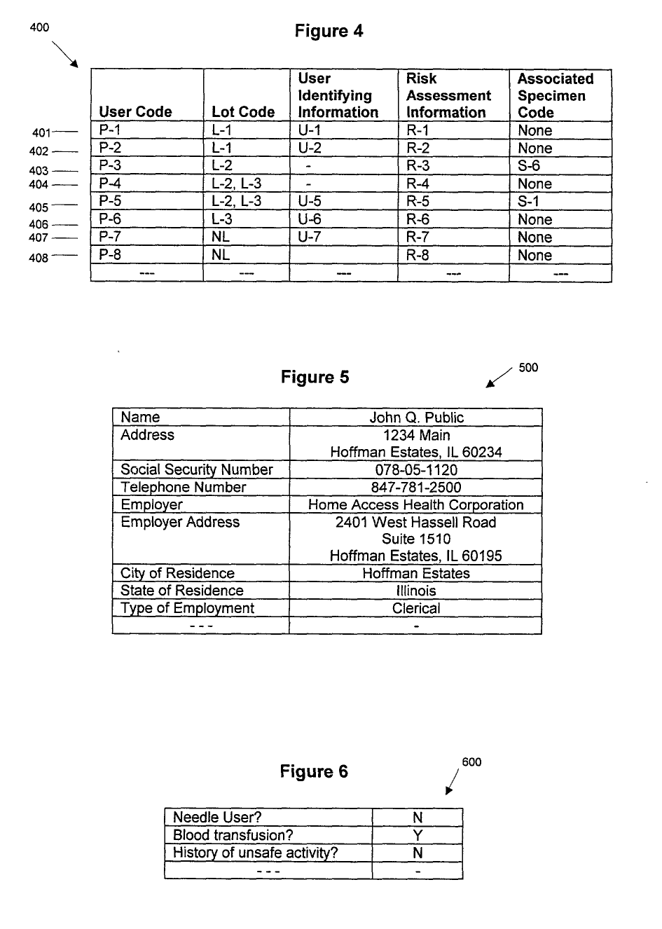

With particular reference to FIG. 4, database 400 includes multiple records (shown, for instance, as records 401 to 408) each of which includes a user code (shown respectively as P-1 through P-8). The term “database” as used herein contemplates the tabular or other information contained and accessed by a database software program. The terms “code” and “number” are used interchangeably herein to refer to any alphanumeric or other designation functioning as an individual code, possibly, but not necessarily, consisting entirely of numbers. The codes preferably contain one or more internal patterns or “check” digits, such that, by applying an appropriate algorithm, a putative code can be verified. Some, but not necessarily all, of the codes in the database are grouped into one or more lots. The lots are identified with a lot code (exemplified as lot codes L-1 through L-3 in FIG. 4), with, for instance, records 401 and 402 being grouped into lot 1, records 403-405 grouped into lot 2, and records 404 through 406 grouped into lot 3. Records 407 and 408 are not assigned a lot code (the designation “NL” in FIG. 4 signifying no lot code assignment). Some of the lots may be exclusive of common codes, as shown, for instance, with respect to lots L-1 and L-3, and some of the lots may be inclusive of some common codes, as shown, for instance with regard to lots L-2 and L-3. Lot L-1, for instance, might signify that that user is an employee of a specific company. Lot L-2 might signify that the user is an employee from a second company, and lot L-3 might signify that the user is from the west coast of the United States. Thus, record 403 corresponds to a user who is an employee of the second company, but who does not reside on the west cost of the United States. Records 404 and 405 in this example would thus correspond to users who were employees of the second company and who did reside on the west coast of the United States, and record 406 would correspond to a user who resided on the west coast of the United States, but who was not known to be an employee of the first or second companies.

Database 400 further may include user identifying information, shown for records 401, 402, 405, 406, and 407 as information U-1, U-2, U-5, U-6, U-7 respectively; risk assessment information for the users (shown as R- 1 through R-8); and, as set forth in more detail below, specimen codes, or codes which identify a specimen submitted by the user. With reference now to FIG. 5, the user identifying information (shown at 500 with regard to database record entry U-1) may include any information deemed suitably appropriate to identify the user, which may include the user's name, address, social security number, telephone number, employer information, and so forth. The user identifying information may be specific user identifying information, i.e., information that enables identification of the user with particularity, or may be more general user identifying information, which is information suitable to identify the user more generally, such as by city or state of residence. Most preferably, the user identifying information includes specific user identifying information, most preferably including both the user's name and social security number. With regard to the risk assessment information contained in the database 400 (shown at 600 in FIG. 6 with respect to database record entry R-1), this information may include any information suitable to enable a diagnostic evaluation of the user's risk for contracting a particular disease. For instance, in the case of hepatitis or HIV evaluation, the risk assessment information may include information as to whether the user has used or shared needles, whether the user has received a blood transfusion in the last 10 years, or whether the user has a history of unsafe conduct or activity that would place the user at risk for contracting HIV or hepatitis, and so forth. The types of information maintained in the database are not limited to the aforementioned specific types of information, but to the contrary many other types of information may be recorded.

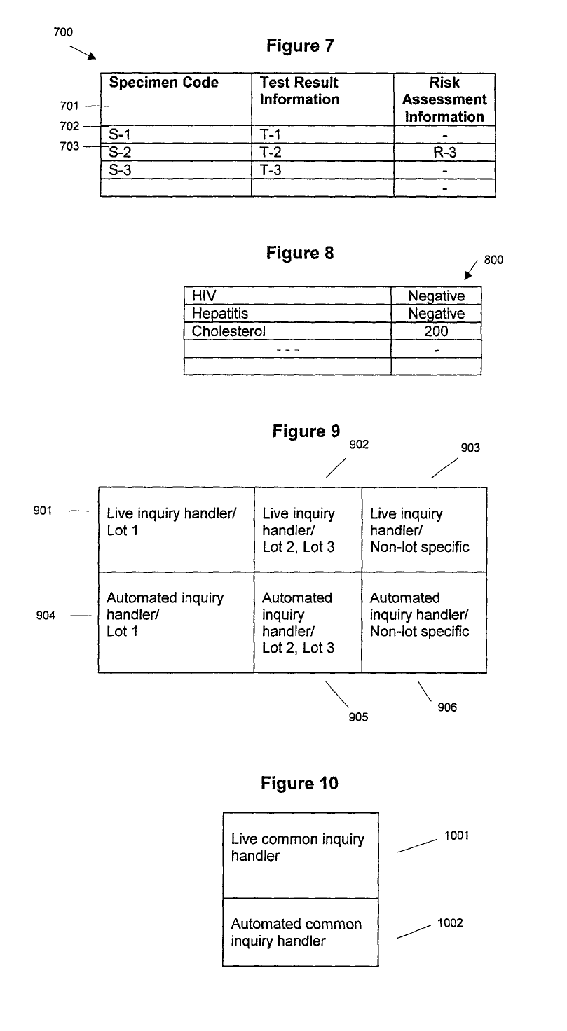

With further reference now to FIG. 7, in certain preferred embodiments the central facility maintains a second database 700, which, in the illustrated embodiment includes records 701, 702, 703. The records in the second database correlate specimen codes to test result information. For instance, with respect to the illustrated database 700, records 701-703 correspond respectively to specimen codes S-1, S-2, and S-3. Record entries T-1, T-2, and T-3 comprise information corresponding to each of the specimens submitted by users in the system. In preferred embodiments, this database further includes record entries for risk factors (e.g., R-3 for record 702), the purpose of which will be explained in more detail hereinbelow. With further reference now to FIG. 8, test result information T-1 may include, for instance, information 800 that indicates whether or not a user is afflicted with a particular medical condition, for instance, infection with HIV or hepatitis. In alternative embodiments, the test result information may be information that provides the results of a qualitative test, for instance, the user's blood cholesterol level.

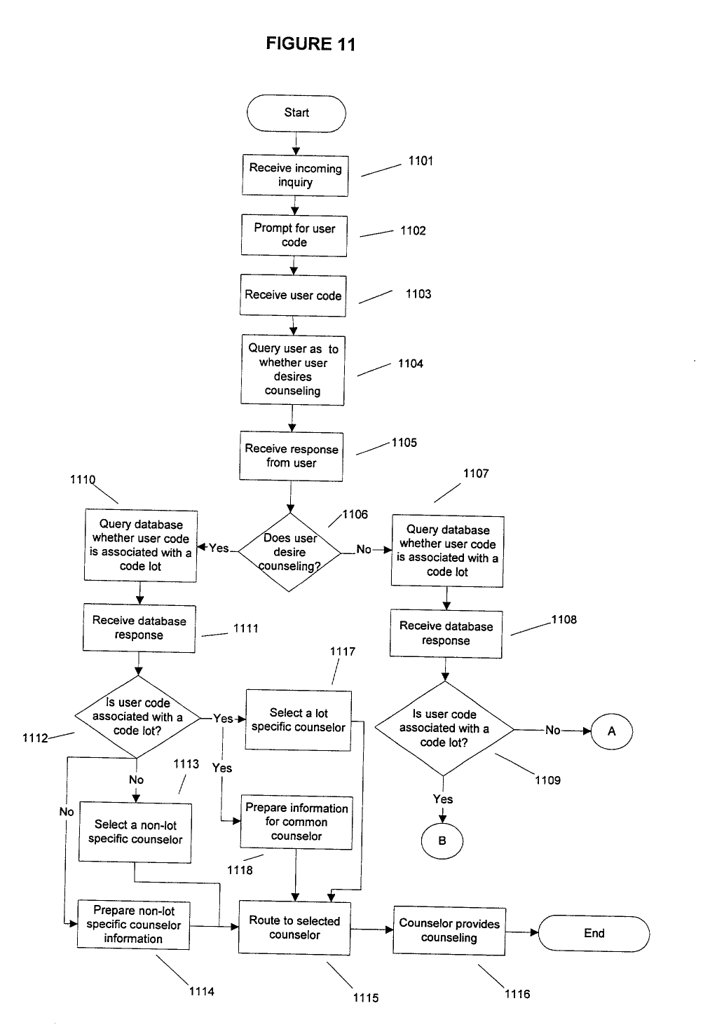

Generally, in accordance with preferred embodiments of the invention, a user initiates an inquiry to the central facility to receive the results of the user's test. The inquiry is routed by the central facility to an inquiry handler. The inquiry handler may be an automated inquiry handler, for instance, a computer equipped with appropriate message handling software, or the inquiry handler may be a live person. As discussed in more detail in the aforementioned Quattrocchi patents, in the case of certain tests, such as tests for HIV, the user's incoming inquiry preferably is routed to a live handler if the user's test result is positive, and to an automated handler if the user's test result is negative. Moreover, as shown in FIG. 9, the bank of inquiry handlers may include inquiry handlers specific for each lot, as well as one or more non-lot specific inquiry handlers. For instance, in the illustrated embodiment inquiry handlers 901 and 904 are allocated to users in lot 1, while inquiry handlers 902 and 905 are allocated to users who fall within lots 2 and 3. Inquiry handlers 903 and 906 are intended for users who are not known to be associated with a given lot. More preferably, however, the inquiry handlers are not assigned solely to users of a given lot. An example of a preferred form of the bank of inquiry handlers is shown in FIG. 10 as including a live common inquiry handler or plurality of such handlers 1001, and an automated common inquiry handler 1002. The live common inquiry handler is an inquiry handler who is not permanently associated with a given lot, but who is provided with instructions for handling an inquiry originating from a user in a given lot. Similarly, the automated common inquiry handler 1002 is an apparatus such as a computer equipped with appropriate messaging software and appropriate messaging capabilities for handling inquiries originating from users who are known to be associated with a given lot of users.

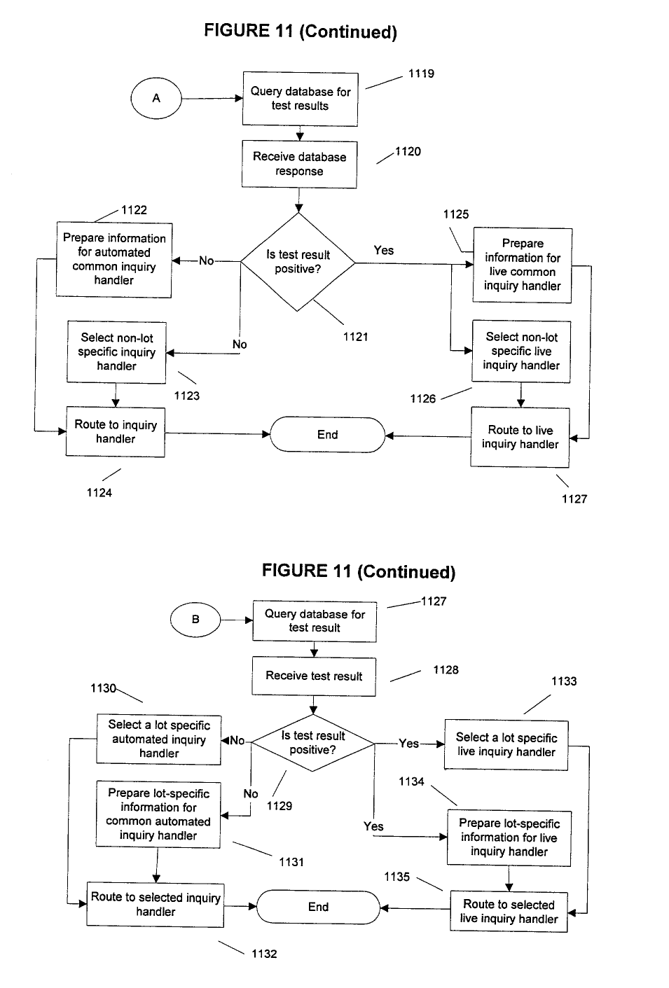

The central facility receives and processes inquires received from users of the testing system. As shown in FIG. 11, the central facility may route a user call depending on whether the user's code is associated with a given code lot. At step 1101, an incoming inquiry is received from the user. It is contemplated by “received from a user” that the call may originate not only from the user who has submitted the medical specimen, but also on behalf of such a user, such as, for instance, by the parent of a child who has submitted a medical specimen. In any event, the user is prompted for his or her user code at step 1102, which code is received at step 1103. At steps 1104 and 1105, the user is queried as to whether counseling is desired, and a response is received. If, at step 1106, it is determined that the user does desire counseling, control passes to step 1110 wherein the user database is queried as to whether the user code is associated with a code lot. A response is received from the database at step 1111. If, at step 1112, it is determined that the user code is associated with a code lot, control passes, in alternate embodiments, to step 117 or 1118, in which respectively a lot specific counselor is selected or lot specific information is prepared for a common counselor. If, at step 1112, it is determined that the user code is not associated with the code lot, in one alternative embodiment a non-lot specific counselor is selected at step 1113 or, in a second alternative embodiment, non-lot-specific information is prepared for a common counselor at step 114. In either case, the user's inquiry is routed to the selected counselor at step 1115, and counseling is provided to the user at step 1116. Again, providing counseling “to the user” may comprise providing counseling to a person who receiving such counseling on behalf of the users, e.g., a parent.

Returning to step 1106, if it is determined that the user does not desire counseling, control passes to step 1107, wherein the database is queried as to whether the user code is associated with a code lot. A response is received from the database at step 1108. If, at step 1109, it is determined that the user code is associated with a code lot, control passes to step 1127, wherein the database is queried for a test result, which result is received at step 1128. If it is determined at step 1129 that the test result is negative, control passes to step 1130 or 1131, in alternative, wherein a lot specific inquiry handler is selected, or wherein lot specific information for a common automated inquiry handler is prepared. In either case, the inquiry is routed to the selected inquiry handler at step 1132. The case of a positive test result is handled similarly. If, at step 1129, the test result is positive, control passes either to step 1133, wherein a lot specific live inquiry handler is selected, or to step 1134, wherein lot specific information for a live inquiry handler is prepared. In either event, the inquiry is routed to the select live inquiry handler at step 1135.

Returning to step 1109, if it is determined that the user code is not associated with a code lot, control passes to step 1119, wherein the test result database is queried for the test results at step 1119. The response is received at step 1120. If, at step 1121, it is determined that the test result is negative, control passes to step 1122, wherein instructions for a common automated inquiry handler are prepared, or to step 1123, wherein a non-lot-specific inquiry handler is selected. In either case, the inquiry is routed to the inquiry handler at step 1124. If, at step 1121, it is found that the test result is positive, control passes alternatively to step 1125 or 1126, in which respectively information for a live common inquiry handler is prepared, or in which a non-lot-specific live inquiry handler is selected. In either case, control passes to step 1127, in which the user's inquiry is routed to a live inquiry handler. FIG. 11 illustrates the case where the test yields a positive or negative result and where a positive test result requires handling by a live inquiry handler. Other tests may be handled in a similar or dissimilar manner. For instance, in the case of a cholesterol test, the user may not need to be routed to a live inquiry handler, regardless of the test result. Alternatively, the user may be routed to a live inquiry handler only in certain cases, e.g., if the user has been found to have a cholesterol level that is deemed dangerously high.

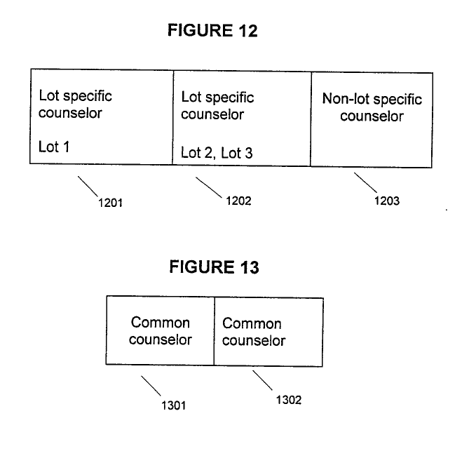

In conjunction with the practice of the aforementioned method, it is useful to provide one or more counselors. As with the alternate embodiments for the bank of inquiry handlers, lot specific counselors 1201, 1202 may be provided as shown in FIG. 12, with one or more non-lot specific counselors (one shown at 1203) further being provided. More preferably, as shown in FIG. 13, one or more common counselors (two being shown at 1301, 1302) are provided. The common counselors are not permanently assigned to users identified as being from a given lot of users, but rather are equipped to provide counseling to the users identified as being in any lot of users. Specific instructions for counseling users identified as being within a given lot of users may be provided to the counselors.

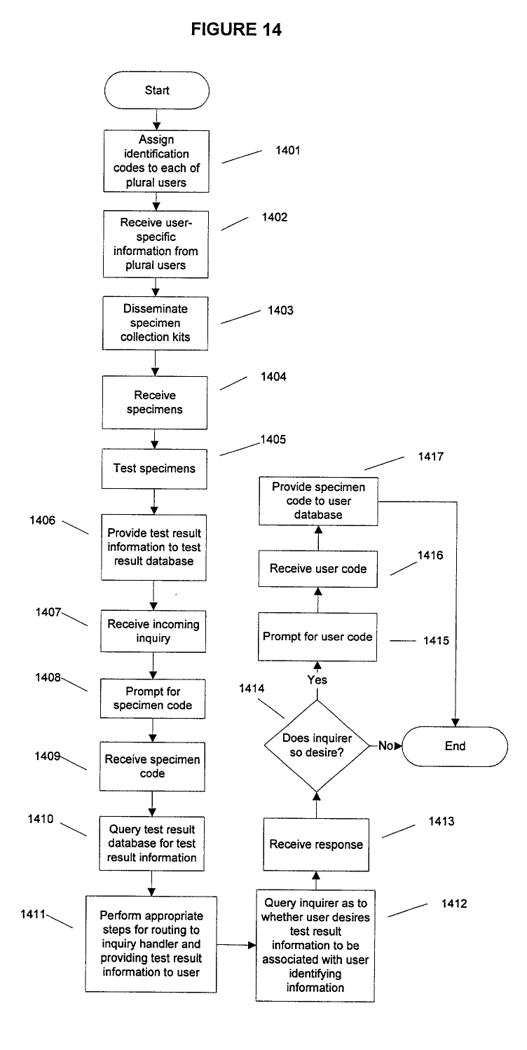

As discussed above, a user may desire user identifying information to be associated with the user's test result information, and, in particular, the user may make this determination after the user has been provided with his or her test result. For instance, as shown in FIG. 14, identification codes may be assigned to each of plural users at step 1401. User-specific information may be received from the users at step 1402 and stored in the user database (step not shown). Specimen collection kits may be disseminated to such users at step 1403. As shown at step 1404, specimens are received from the users, which specimens are tested at step 1405. Not all of these steps may be performed by the central facility, particularly if the testing facility is a separate entity. The specimens preferably are identified with a specimen code, but are not identified with the user code. After the specimens have been tested, the results of the test are provided to the test result database (e.g., database 700 as shown in FIG. 7).

At step 1407, an incoming inquiry is received. The user is prompted for his or her specimen code at step 1408, which code is received at step 1409. At step 1410, the test result database is queried for the test result information corresponding the specimen code entered by the user. Step 1411 in FIG. 14 contemplates performance of appropriate steps for routing the users inquiry to an inquiry handler and providing test result information to the user. After the user has been provided with his or her test result, the user is queried at step 1412, as to whether the user desires test result information to be associated with user identifying information. A response from the user is received at step 1413. If, at step 1414, it is determined that the person making the inquiry does so desire, the user is prompted for his or her user code at step 1415, which code is received at step 1416. At step 1417, the specimen code is provided to the user database to thereby associate test result information with user identifying information. Thus, for instance, referring again to FIG. 4 and record 405, this user has chosen to associate his or her test result information with user identifying information, as is evidenced by the inclusion of specimen code S-1 in record 405. Other users, for instance, those associated with records 401 and 402, have not chosen to associate test result information with user identifying information.

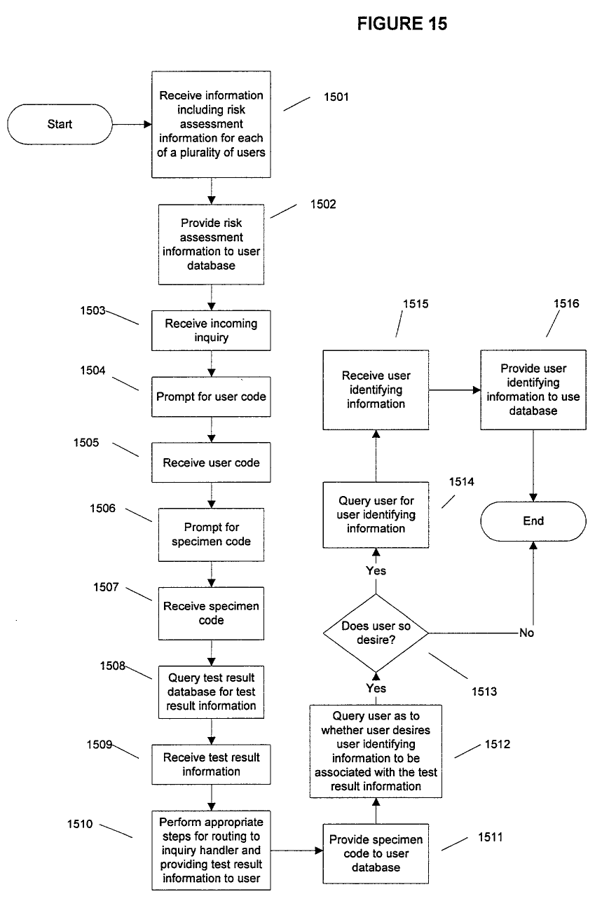

In another method for associating test result information with user identifying information, information that includes at least risk assessment information is received from each of a plurality of users, as shown in step 1501 in FIG. 15. This risk assessment information is provided to a user database in conjunction with a user code, as shown in step 1502. At steps 1503, an incoming inquiry from one of the users is received. The user is prompted for the user code at step 1504, which code is received at 1505. At step 1506, the user is prompted for his or her specimen code, which is received at step 1507. Up to this point, the user has not provided specific user identifying information to the central facility. Record 403 in FIG. 4 illustrates a user, for instance, whose specimen code has been provided to the user's database, but for whom user identifying information has not been entered into the user database.

At steps 1508 and 1509, the test result database is queried for test result information, which is received at step 1509. Box 1510 contemplates performing appropriate steps for routing the user to an inquiry handler and providing test result information to the user. At step 1511, the user's specimen code is provided to the user database. At step 1512, the user is queried as to whether he or she desires user identifying information to be associated with the test result information. If, at step 1513, it is determined that the user does so desire, control passes to step 1514, wherein the user is queried for user identifying information. The user identifying information is received at step 1515 and is provided to the user database at step 1516.

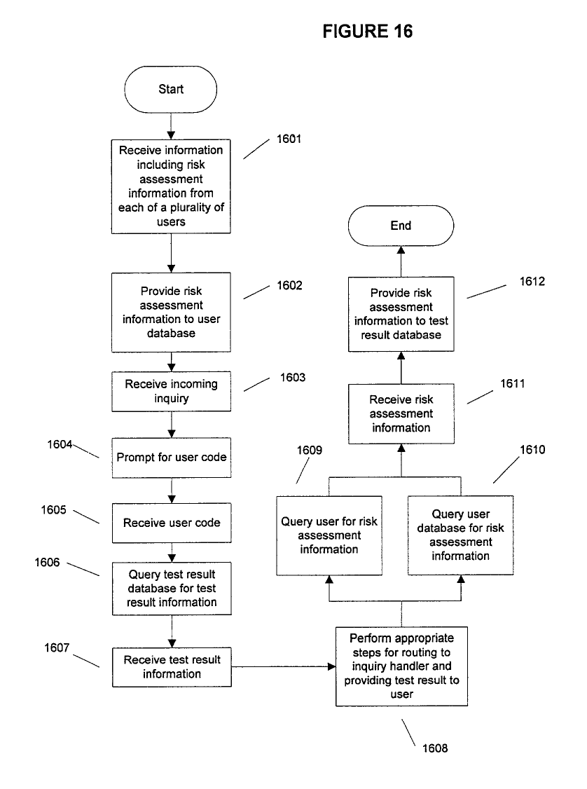

As shown in FIG. 16 in another embodiment of the invention, test result information may be associated with risk assessment information to thereby permit statistical or other analysis of the test result and risk assessment information. At step 1601, information, including risk assessment information, is received from each of a plurality of users. This risk assessment information is provided to the user database at step 1602, and is associated with a user code for each user. At step 1603, an incoming inquiry from one of the users is received. The user is prompted for his or her user code at step 1604, and the user code is received at step 1605. At step 1606, the test result database is queried for test result information from a test specimen submitted by the user. Preferably, this is accomplished by prompting the user for a specific code associated with the test specimen (step not shown). The test result information is received at step 1607. Box 1608 contemplates the performance of appropriate steps for routing the user's inquiry to an inquiry handler and providing test result information to the user. Control next passes to step 1610, wherein the user database is queried for risk assessment information, which information is received at step 1611 and is provided to the test result information at step 1612. Thus, with respect to record 702 in FIG. 7, risk assessment information R-3 has been provided to the test result database. FIG. 16 also contemplates an alternative embodiment in which the user is queried for risk assessment information at step 1609. In this embodiment, the user need not have been assigned a user code.

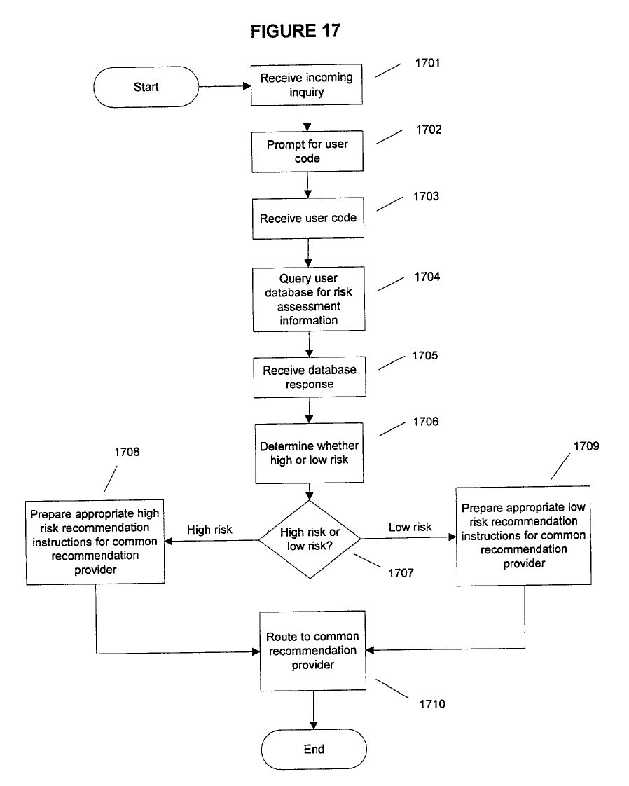

The central facility further may be equipped to prepare an appropriate recommendation to a user to obtain testing based on risk assessment information provided by the user. For instance, as shown in FIG. 17, an incoming inquiry is received at step 1701 from a user who has provided risk assessment information. At step 1702, the user is prompted for his or her user code, which is received at step 1703. At step 1704, the user database is queried for risk assessment information. It is contemplated that the user may be queried for such risk assessment information (step not shown), if the risk assessment information is not in the database. In the illustrated embodiment, a response from the database is received at step 1705, and a determination is made whether the user is at high risk or low risk at step 1706 for affliction with a given medical condition. If, at step 1707, the user is determined to be at high risk, high risk recommendation instructions for a common recommendation provider are prepared at step 1709. If, on the other hand, the user is determined to be at low risk, low risk recommendation instructions for a common recommendation provider are prepared at step 1709. In either case, the user's inquiry is routed to common recommendation provider at step 1710. The “high” and “low” risk determinations are contemplated to include embodiments wherein the user has certain scores on a quantitative or qualitative test. For instance, in the case of a cholesterol test, a user whose cholesterol count is above a predetermined level may be deemed at high risk of a plurality of disorders.

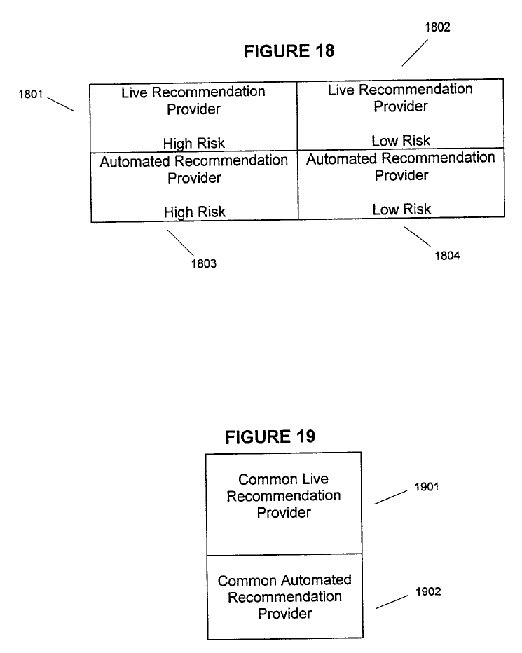

As shown in FIGS. 18 and 19, the recommendation providers may be grouped into live and automated recommendation providers, each assigned to high risk and low risk categories (as shown in FIG. 18 with respect to high risk and low risk live recommendation providers 1801 and 1802 and high risk and low risk automated recommendation providers 1803 and 1804). In such case, instead of preparing instructions for a recommendation provider (e.g. step 1709 in FIG. 17), the specific recommendation provider is selected. More preferably, the recommendation providers include one or more common live recommendation providers (one shown at 1901 at FIG. 19) and one or more common automated recommendation providers (shown at 1902). The common recommendation providers are equipped to provide both high risk and low risk recommendations to the user.

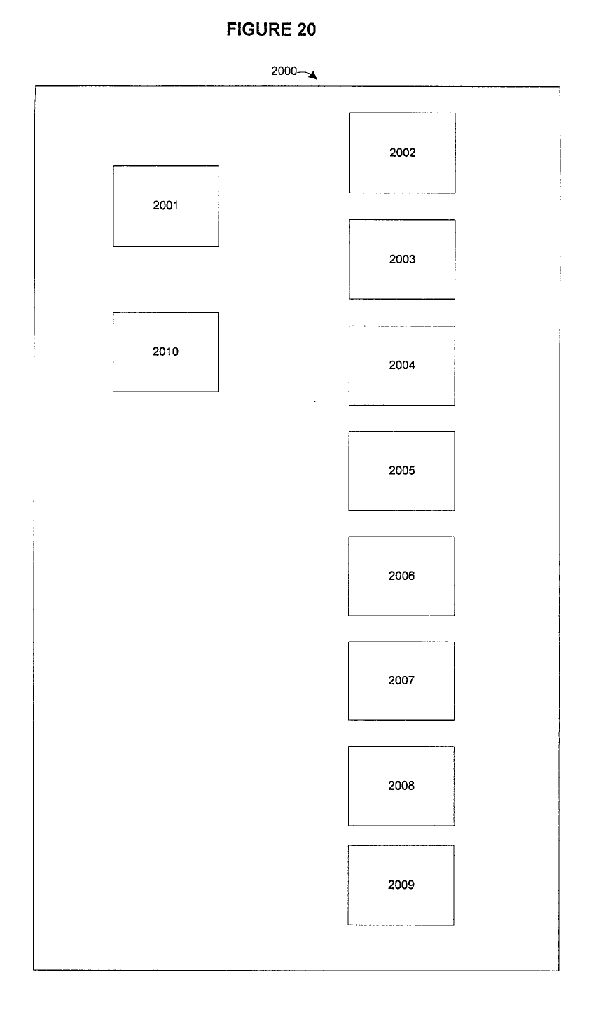

Generally, the handling of inquiries by the central facility may be accomplished using any commercially available or otherwise suitable computer system. As shown in FIG. 20, a suitable computer system 2000 preferably includes a central processing unit 2001; input/output devices, such as a hard disk drive 2002, floppy disk drive 2003, a CD-ROM drive, 2004, a keyboard 2005, network interface equipment 2006, a display adapter 2007, a modem 2008, a monitor 2009, and so forth; and computer memory 2010. The methods may be practiced using any suitable software, by which is contemplated any computer processable instruction set, including programs and program modules. Program modules include routines, objects, components, data structures, and the like that comprise or implement data types or that perform one or more tasks. The invention may be practiced with other computer system configurations, including hand-held devices, multiprocessor systems, microprocessor-based or programmable electronics, minicomputers and mainframes, and the like. The invention may be practiced in a distributed computing environment where tasks are performed by one or more remote processing devices that are linked through a communications network. In a distributed computing environment, program modules may be located in both local and remote memory storage devices. In the description hereinabove, the invention is described with reference to acts and operations that are performed by one or more computers. Such acts and operations include the manipulation of electrical signals representing data in a structured form, in a manner well understood by those skilled in the art.

The steps shown in any of the foregoing figures and discussed above may be performed in any appropriate order, and thus the figures should be seen as exemplifying the practice of the methods and systems disclosed herein, not as limiting these methods or systems. Similarly, where appropriate other steps may be added, or steps may be omitted. For instance, the Figures are intended to provide an overview of the methods and system disclosed herein, and in practice other steps (e.g., error checking) may be performed. The steps may be practiced by one or several entities.

Thus, it is seen that various testing methods and systems are provided herein. The methods and systems are particularly useful in connection with medical testing.

While this invention has been described with an emphasis upon preferred embodiments, it will be apparent to those of ordinary skill in the art that variations of the preferred embodiments may be used and that it is intended that the invention may be practiced otherwise than as specifically described herein. Accordingly, this invention includes all modifications and equivalents encompassed within the spirit and scope of the invention as defined by the following claims. All references cited herein are hereby incorporated by reference in their entireties.

What is claimed is:

1. In a testing system, a method for routing a plurality of in-coming inquiries initiated by a plurality of users, each of said users having previously provided a specimen for evaluation to a testing facility prior to making an incoming inquiry, said evaluation of said specimen yielding test result information, said test result information being associated with a personal identification code, said personal identification code being associated with a code database comprising a plurality of codes in which at least one sub-set of said plurality of codes is associated with a code lot, the method comprising the steps of:
receiving an inquiry initiated by one of said users;
prompting said user to transmit said personal identification code;
receiving said personal identification code;
determining whether said personal identification code input by said user is associated with a code lot;
from among a plurality of inquiry handlers, including at least one inquiry handler associated with said code lot, selecting an inquiry handler associated with said lot if said personal identification code is determined to be associated with said lot; and
routing said inquiry to the selected inquiry handler.

2. A method according to claim 1, further comprising the step of retrieving in response to said personal identification code test result information associated with said personal identification code.

3. A method according to claim 2 further comprising the step of providing said test result information to said user.

4. A method according to claim 2, wherein said step of retrieving test result information is performed prior to routing said inquiry to said selected inquiry handler.

5. A method according to claim 1, wherein said code database includes a plurality of code lots.

6. A method according to claim 5, wherein at least two of said code lots are exclusive of common codes.

7. A method according to claim 1, wherein for at least one code lot, said plurality of inquiry handlers includes a plurality of inquiry handlers associated with said code lot, said method further including the step of selecting an inquiry handler from among the plurality of inquiry handlers associated with said lot.

8. A method according to claim 7, the method including the step of selecting one of said inquiry handlers associated with said lot based upon said test result information.

9. A method according to claim 8, wherein said plurality of inquiry handlers for said lot includes at least one live inquiry handler and at least one automated inquiry handler.

10. A method according to claim 1, wherein said inquiry is made via electronic communication.

11. A method according to claim 3, wherein said test result information is provided to said user via electronic communication.

12. A method according to claim 1, wherein some of the codes in said code database are not associated with a lot, said plurality of inquiry handlers including at least one non-lot-specific inquiry handler.

13. A method according to claim 12, said plurality of inquiry handlers including a plurality of non-lot-specific inquiry handlers, the method including the step of selecting one of said non-lot-specific inquiry handlers if it is determined that said personal identification code input by said user is not associated with a lot.

14. A method according to claim 13, the method including the step of selecting one of said non-lot-specific inquiry handlers based upon test result information.

15. A method according to claim 1, wherein said code database comprises a plurality of code lots, wherein at least one of said plurality of inquiry handlers is associated with plural code lots.

16. A method according to claim 1, wherein said specimen is a medical specimen and said evaluation is a medical evaluation.

17. A method according to claim 16, wherein said evaluation is an evaluation for HIV.

18. A method according to claim 16, wherein said evaluation is an evaluation for hepatitis.

19. A method according to claim 1, wherein said specimen is an environmental specimen and said evaluation is an environmental evaluation.

20. A method according to claim 1, wherein said plurality of inquiry handlers comprises at least one common inquiry handler provided with instructions associated with said code lot, wherein said step of selecting an inquiry handler comprises selecting instructions for said common inquiry handler.

21. In a testing system, a method for routing a plurality of incoming inquiries initiated by a plurality of users, said users submitting test specimens for evaluation to a testing facility, each of said users being associated with a personal identification code, said personal identification code being associated with a code database comprising a plurality of codes in which at least one subset of said plurality of codes is associated with a code lot, the method comprising the steps of:
receiving an inquiry initiated by one of said users;
prompting said user to transmit said personal identification code;
receiving said personal identification code; in any order
querying said user as to whether said user desires counseling; and
determining whether said personal identification code input by said user corresponds to a code lot;
from among a plurality of counselors, including at least one counselor associated with said lot, selecting a counselor associated with said lot if said personal identification code is determined to be associated with said lot; and
routing said inquiry to said counselor.

22. A method according to claim 21, further comprising the step of providing counseling to said user.

23. A method according to claim 21, wherein said code database includes a plurality of code lots.

24. A method according to claim 23, wherein at least two of said code lots are exclusive of common codes.

25. A method according to claim 21, wherein for at least one code lot, said plurality of counselors includes a plurality of counselors associated with said code lot, said method further including the step of selecting a counselor from among the plurality of counselors associated with said lot.

26. A method according to claim 25, wherein said plurality of counselors for said lot includes at least one live counselor and at lest one automated counselor.

27. A method according to claim 21, wherein said inquiry is made via electronic communication.

28. A method according to claim 22, wherein said counseling is provided to said user via electronic communication.

29. A method according to claim 21, wherein some of the codes in said database are not associated with a lot, said plurality of counselors including at least one non-lot-specific counselor.

30. A method according to claim 29, said plurality of counselors including a plurality of non-lot-specific counselors, the method including the step of selecting one of said non-lot-specific counselors if it is determined that said personal identification code input by said user is not associated with a lot.

31. A method according to claim 21, wherein said code database comprises a plurality of code lots, wherein at least one of said plurality of counselors is associated with plural code lots.

32. A method according to claim 21, wherein said specimen is a medical specimen and said evaluation is a medical evaluation.

33. A method according to claim 32, wherein said evaluation is an evaluation for HIV.

34. A method according to claim 32, wherein said evaluation is an evaluation for hepatitis.

35. A method according to claim 21, wherein said specimen is an environmental specimen and said evaluation is an environmental evaluation.

36. A method according to claim 21, wherein said plurality of counselors comprises at least one common counselor provided with instructions associated with said code lot, wherein said step of selecting a counselor comprises selecting instructions for said common counselor.

37. A method according to claim 21, wherein said inquiry is received prior to submission of a test specimen.

38. A method according to claim 21, wherein said inquiry is received prior to providing test result information to the user.

39. A method according to claim 21, wherein said user is queried as to whether said user desires counseling after said user has received test result information.

40. A method according to claim 21, wherein said user is anonymously identified by one of said personal identification codes.

41. A method according to claim 21, wherein said personal identification code is associated with the test specimen submitted by said user.

42. A method according to claim 41, wherein said user has a different personal identification code that is associated with user-identifying information.

43. A method according to claim 41, wherein said personal identification code is not associated with user-identifying information.

44. In a testing system, a method for handling a plurality of incoming inquiries initiated by a plurality of users, the method comprising the steps in any appropriate order of:
receiving information associated with a plurality of users, the information from any one user being specific to said user and being associated with a first identification number;
receiving an incoming inquiry initiated by one of said users;
obtaining test result information from a test specimen submitted to a testing facility by said user, said test specimen being identified by one of a plurality of second identification numbers;
prompting said user to transmit the second identification number associated with the user's test specimen;
querying said user as to whether said user desires test result information to be identified with the information specific to said user;
in response to an indication from said user that said user does desire said test result information to be identified with said information specific to said user,
prompting said user for said first identification number associated with said information specific to said user;
receiving said first identification number from said user; and
associating said information specific to said user with said test result information.

45. A method according to claim 44, further comprising the step of routing said inquiry to an inquiry handler.

46. A method according to claim 45, further comprising the step of providing test result information to said user.

47. A method according to claim 46, wherein said user is queried as to whether said user desires said test results to be identified with said information specific to said user after said test result information has been provided to said user.

48. A method according to claim 44, further comprising the step of testing said specimen to obtain said test result information.

49. A method according to claim 44, further comprising the steps of providing a specimen collection kit to each of said plurality of users.

50. A method according to claim 44, further comprising the step of assigning a first identification number to each of said plurality of users.

51. A method according to claim 50, further comprising the step of providing a specimen collection kit to each of said plurality of users.

52. A method according to claim 51, wherein for at least one user, a first identification number is assigned prior to providing a specimen collection kit to said user.

53. A method according to claim 44, wherein said information specific to said user includes risk assessment information.

54. A method according to claim 53, wherein said information specific to said user does not include user-identifying information.

55. A method according to claim 53, wherein said information specific to said user includes user-identifying information.

56. A method according to claim 44, wherein said inquiry is made via electronic communication.

57. A method according to claim 46, wherein said test result is provided to said user via electronic communication.

58. A method according to claim 44, wherein said test is an environmental test.

59. A method according to claim 44, wherein said inquiry is an anonymous inquiry received from one user of a group of known users.

60. A method according to claim 44, wherein said test kit is a medical test and said test result information is medical information.

61. A method according to claim 60, wherein said test is a test for HIV.

62. A method according to claim 60, wherein said test is a test for hepatitis.

63. In a testing system, a method for handling a plurality of incoming inquiries initiated by a plurality of users, the method comprising the steps in any appropriate order of:
receiving information associated with a plurality of users, the information from any one user being specific to said user and being associated with a first identification number, said information including risk assessment information;
receiving an incoming inquiry initiated by one of said users; prompting said user to transmit said first identification
number associated with said information specific to said user; obtaining test result information from a test specimen
submitted to a testing facility by said user, said test specimen being identified by one of a plurality of second identification numbers;
prompting said user to transmit said second identification number associated with the user's test specimen; and
relating said test result information to said risk assessment information.

64. A method according to claim 63, wherein said user information specific to said user further includes user-identifying information, the method including the steps of:
querying said user as to whether said user desires said user-identifying information to be associated with said test result; and
if said user does desire said user-identifying information to be associated with said test result information, associating said user-identifying information with said test result information.

65. A method according to claim 64, wherein said user identifying information is related to said test result information by relating said user identifying information to said risk assessment information.

66. A method according to claim 63, further comprising the steps of:
querying said user as to whether said user desires user-identifying information to be associated with said test result information,
if said user does desire user-identifying information to be associated with said test result information, relating said user-identifying information to said test result information.

67. A method according to claim 66, further comprising the step of querying said user for at least a portion of said user-identifying information.

68. In a testing system, a method for handling a plurality of incoming inquiries from a plurality of users, the method comprising the steps in any appropriate order of:
receiving information associated with a plurality of users, the information from any one user being specific to said user and being associated with a first identification number, said information including risk assessment information;
receiving an incoming inquiry initiated by one of said users;
prompting said user to transmit said first identification number associated with said information specific to said user;
obtaining test result information from a test specimen submitted to a testing facility by a user;
querying said user as to whether said user desires user-identifying information to be associated with said test result information;
in response to an indication from said user that said user desires user-identifying information to be identified with test result information, associating user-identifying information with said test result information.

69. A method according to claim 68, further comprising the step of providing test result information to said user.

70. A method according to claim 68, further comprising the step of querying said user for at least a portion of said user-identifying information.

71. A method according to claim 68, wherein said information specific to said user includes at least a portion of said user-identifying information.

72. A method according to claim 68, wherein said information specific to said user includes risk assessment information.

73. A method according to claim 72, wherein said method includes the step of associating said risk assessment information with said test result information.

74. A method according to claim 72, wherein said method includes the steps of:
querying said user as to whether said user desires risk assessment information to be associated with said test result information, and
associating said risk assessment information with said test result information if said user indicates that said user desires said test result information to be associated with said risk assessment information.

75. In a testing system, a method for handling a plurality of incoming inquiries initiated by a plurality of users, the method comprising the steps in any appropriate order of:
receiving information associated with a plurality of users, the information from any one user being specific to said user and being associated with a first identification number, said information including risk assessment information;
receiving an inquiry initiated by one of said users;
prompting said user to transmit said first identification number associated with said information specific to said user;
obtaining test result information from a test specimen submitted to a testing facility by said user; and
associating said test result information with said risk assessment information.

76. A method according to claim 75, including the step of querying said user for said user-identifying information.

77. A method according to claim 76, further comprising the step of routing said inquiry to an inquiry handler.

78. A method according to claim 77, further comprising the step of providing test result information to said user.

79. In a testing system, a method for evaluating information comprising the steps in any appropriate order of:
receiving risk assessment information from a plurality of users, the risk assessment information from any one user being specific to said user and being associated with a first identification number;
receiving an inquiry from one of said users;
prompting said user to transmit said first identification number associated with said information specific to said user;
obtaining a determination as to whether based on said risk assessment information a recommendation to obtain testing should be provided to said user, and
selecting an appropriate recommendation provider from among a plurality of recommendation providers based on said determination; routing said inquiry to the selected recommendation provider.

80. A method according to claim 79, wherein said inquiry is received via electronic communication.

81. A method according to claim 79, further comprising the step of providing a recommendation to said user.

82. A method according to claim 81, wherein said recommendation is provided via electronic communication.

83. A method according to claim 79, wherein said plurality of recommendation providers includes at least one common recommendation provider, wherein said step of selecting an appropriate recommendation provider comprises selecting instructions for said common recommendation provider.
